(19) United States
(12) Patent Application Publication
(10) Pub. No.: US 2010/0211934 A1
(43) Pub. Date: Aug. 19, 2010

(54) APPARATUS AND METHOD FOR SERVICE-ENABLING COMPUTER PROGRAMS

(76) Inventors: David Simons, Toronto (CA); Kelly Slough, Northampton, MA (US); Chris Micacchi, Toronto (CA); Girish Limaye, Sunnyvale, CA (US); Vince Duong, Mountain View, CA (US); Andrew Wahbe, Toronto (CA); Robert Szumlakowski, Woodstock (CA); Steven Woods, Petersburg (CA)

Correspondence Address: FOLEY & LARDNER LLP, 150 EAST GILMAN STREET, P.O. BOX 1497, MADISON, WI, 53701-1497, US

(21) Appl. No.: 12/388,121

(22) Filed: Feb. 18, 2009

(51) Int. Cl. G06F 9/44; G06F 9/445; G06F 21/22

(52) U.S. Cl. 717/126; 717/168; 717/174; 726/27

(57) ABSTRACT

A method of injecting services into a computer program includes analyzing the computer program to evaluate its technologies. The method further includes identifying objects within the running computer program to inform an injected service that an event has occurred, and modifying the computer program so that the injected service responds to an occurrence of the determined object.

### FIELD

The subject of the disclosure relates generally to injection of a service into a computer program and to advertising within a gaming environment. More specifically, the disclosure relates to an apparatus and method for service-enabling software games.

### SUMMARY

Game developers have traditionally generated their revenue from game sales. However, in recent years, in-game advertising has been utilized to provide game developers with a secondary revenue stream. In-game advertising generally refers to inserting paid advertisements into a game such that the advertisements can be displayed to a player of the game. Traditionally, the advertisements are inserted into the game by incorporating a third party software development kit (SDK) or other code into the source code of the game. As such, the advertisements can be presented to the player as videos at selected times within the game, as billboards within the game, as banners within the game, as trademarks placed on products which are used during the game, etc.

Because in-game advertisements are incorporated into the source code, advanced planning and programming is required during the game development phase to implement in-game advertising. For example, placing advertisements on billboards within a gaming environment requires programmers to set aside space for and/or create billboard surfaces within the source code. As a result, game programmers require more time to create the game. Unfortunately, this additional time spent developing the game pushes back the release date of the game and increases the overall cost of placing the game on the market. Incorporating advertisements into the source code also limits the ability of game developers to add advertisements to games which are already on the market. To place advertisements in released games, the game developers must hire programmers to rewrite the game's source code, re-package the game, and/or redistribute the game. Using these traditional methods for placing advertisements within games, game developers are often unable to ad-enable their historical games as well as their recently developed games. In addition, because there is no standard advertising SDK, if a game developer wants to support several ad networks, the game developer has to write a different version of the game using the SDK specific to each ad network. Thus, in order to support different ad networks, game developers must develop a different version of the game for each ad network. Developing a new version of a game for each ad network is not economically viable.

In addition, it is often desirable to display content other than advertisements within a game. This content may include any type of information that someone may wish to present to a game player. Example non-limiting content may include surveys, achievement levels, or notifications that other players are online. The content may also be interactive or non-interactive.

Recently, in-game advertising and content display methods which allow a game developer to insert services into a game without advanced planning or modification of the game's source code have been developed. To support this service insertion method and to increase productivity of service-enabling games to an efficient and profitable level, a tool-supported editorial process enables the selection of spots within the game. The selected spots may be used to inform an injected service that an event has occurred and the injected service may respond accordingly to the selected spot. The inject service may cause content such as advertisements to be inserted. This way a service-enabled game can be produced by a service enablement tool which can be run efficiently, effectively, and profitably. This tool-supported editorial process allows operators with minimal technical experience to edit existing games and insert services which may allow for insertion of advertisements or other forms of content. Due to this relative ease with which operators may edit and insert advertisements within games, game portals may affordably modify game versions and associated business models because different versions of games may be easily developed. As such, game portals no longer must request the game developer or publisher change the source code of a game each time a game portal wishes to modify an advertisement scheme associated with the game. Instead, game portals can utilize the service enablement tools as described below to quickly and affordably modify advertisement and other content display schemes within games.

A representative implementation includes a toolset and process by which spots within computer programs are selected for content insertion and the subsequently service enabled computer program is produced. In an exemplary embodiment, the computer program is a software game. The selected spots within the program may be used to trigger potential presentation of content such as advertisements according to a service policy. The service policy establishes what content or advertisements will be presented in the computer program or game at the selected trigger spots. While the types of enhancements that can be made with this toolset are virtually unlimited, the current process applies most directly to enhancements related to adding in-game advertising and integration with community services such as Microsoft's LIVE! And Facebook. The types of advertising that can be enabled with this toolset and process include but are not limited to pre-roll, interstitial, post-roll, and overlay ads that occur during natural breaking points in game play, and overlay ads that appear during game play without being overly intrusive on the game play experience.

In a first representative embodiment, a method of injecting a service into a computer program includes analyzing a computer program via a program analyzer to determine if the program may be service-enabled, determining an object within the program, and modifying the program via a service enablement tool to cause insertion of an injected service into the program where the injected service responds to an occurrence of the object.

In a second representative embodiment, a device for injecting a service into a computer program includes an application, a memory, and a processor. The application itself has a computer program configured to run a target program, define at least one object from the target program in response to a first user input, and insert a service into the computer program. The service is configured to respond to an occurrence of the at least one object. The executable file is configured to allow the content to be presented when the selected object is detected. The memory is configured to store the application. The processor is coupled to the memory and is configured to execute the application.

In a third representative embodiment, a tool for injecting a service into a game includes a program analyzer configured to analyze video and audio technologies of a game; a service enablement tool configured to receive a selected spot within the game and configured to modify the game by inserting a service into the game so that the service responds to an occurrence of the selected spot.

Other principal features and advantages will become apparent to those skilled in the art upon review of the following drawings, the detailed description, and the appended claims.

### BRIEF DESCRIPTION OF THE DRAWINGS

Representative embodiments are described with reference to the accompanying drawings.

FIG. 1 is a flow diagram illustrating operations performed by a system for enabling a service within a computer program.

FIG. 2 is a flow diagram illustrating the functions performed by a service enablement tool in a system for enabling a service within a computer program in accordance with FIG. 1.

FIG. 3 is a flow diagram illustrating processes performed to enable a service within a computer program by utilizing a service enablement tool.

FIG. 4 is a graphical user interface (GUI) for creating a new project in a service enablement tool.

FIG. 5 is a GUI of a project properties window of a service enablement tool.

FIG. 6 is a GUI of a service enablement tool.

FIG. 7 is a flow diagram illustrating processes performed to package and brand a service-enabled computer program.

FIG. 8 is a flow diagram illustrating processes performed to test an service-enabled computer program.

FIG. 9 is a block diagram of a post deployment reporting infrastructure.

FIG. 10 is a flow diagram of post deployment analysis.

### DETAILED DESCRIPTION

Please note that throughout the subsequent description a service-enablement technician is referenced. A service-enablement technician is an individual who operates a service-enablement tool and is meant to signify any individual who uses the below-referenced service-enablement tools or process. A service-enablement technician need not have special knowledge or training in software development, service- or ad-enablement, game development, or any other area of expertise and is not meant to exclude any individual who operates or uses a below-referenced tool.

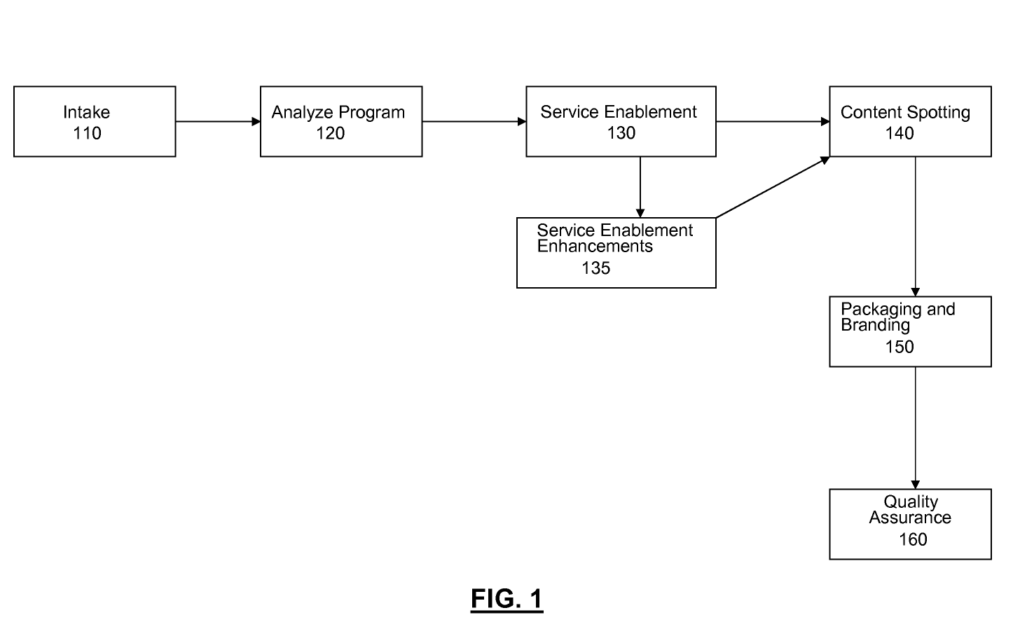

FIG. 1 is a flow diagram illustrating operations performed by a system for injecting a service into a computer program in accordance with a representative embodiment. According to an embodiment, the injected service allows for the display of content (e.g., advertisements) within computer programs. Additional, fewer, or different operations may be performed in alternative embodiments. A person of skill in the art will also recognize that the tools and operations as described below may also be applied to computer programs other than games, thus enabling service enablement in any type of computer program. In an intake operation 110, possible games in which services may be enabled are prioritized. The prioritization of the games may be based on any desired and selected factors. Example prioritization factors include the probability of successful enablement of the ads, the expected number of ads per download, and the game popularity. Prioritization of games may be supported by a series of spider programs which “crawl” or search various gaming portals to determine what games are listed on the portals and to extract popularity rankings. Information gathered by the spider programs may be written to a database. The popularity information stored in the database may be used to generate reports on the popularity of selected games. An appropriate game is then selected based on the prioritization factors.

In an operation 120, the selected game is analyzed to determine if the game can be service-enabled. As such, the game may be analyzed to determine if enablement services can be injected into the game and to identify the core video and audio technologies used to build the game. The analysis can include examination of the game executable itself (including any available version or file identification information), as well as running the game to examine the external libraries used during game play (such as DirectX). Additional or less information about the game may be analyzed according to various embodiments. The game analysis may be performed by a program analyzer. The program analyzer may be stored as a computer readable medium on a memory of a computer and processed by a CPU of a computer. A display may also be operatively coupled to the memory and the CPU and may present visual representations and interfaces of the program analyzer.

If it is determined that services may be injected into the game, the game is service-enabled in an operation 130. In an exemplary embodiment, to service-enable the game, the executable file for the game executable is modified so that an enablement service may intercept all calls made by the game to the underlying graphics and sound libraries used by the game, as well as certain core operating system functions required by the service. Later, when the game is being played and a call is made for a particular object within the game, the enablement service may answer the call with content for insertion or by initiating a community service such as integration with other services such as Microsoft's Live! And Facebook. Files necessary for advertisement content and security may also be included with the game. To enable the game, the game's executable must be modified to incorporate the service-enabling code. The executable file of the game (identified on computers running the Windows operating system by an “.exe” file extension) is the output that is produced when the source code for the game is compiled and linked. In an alternative embodiment, the executable file is modified so that the modified executable will be linked to an enablement service. The linking can be accomplished by altering the binary executable in a subtle way such that when the executable is run by the user, it will as its first action, cause the enablement service to be loaded into the game process. The enablement service may be linked to the graphics library so that the enablement service can monitor graphical element requests received by the graphical library and/or graphical elements provided by the graphical library. All calls made from the game to the graphics library can be intercepted and inspected to determine when the game calls for the identified graphical element. The intercepted calls can then be forwarded to the graphics library. In addition, the enablement service may also intercept calls to sound libraries, window functions, and other calls made from the game to facilitate control of the game when content such as an advertisement is to be played or displayed. Service enablement may be performed by a service enablement tool 210 as described below.

If the game fails service enablement for any reason, i.e., the current service enablement process does not work for the given game technologies, the game may be passed to a service enablement engineering team at an operation 135. In operation 135, tool and service enablement enhancements may be conducted to conform the enablement tools and service to the failed game.

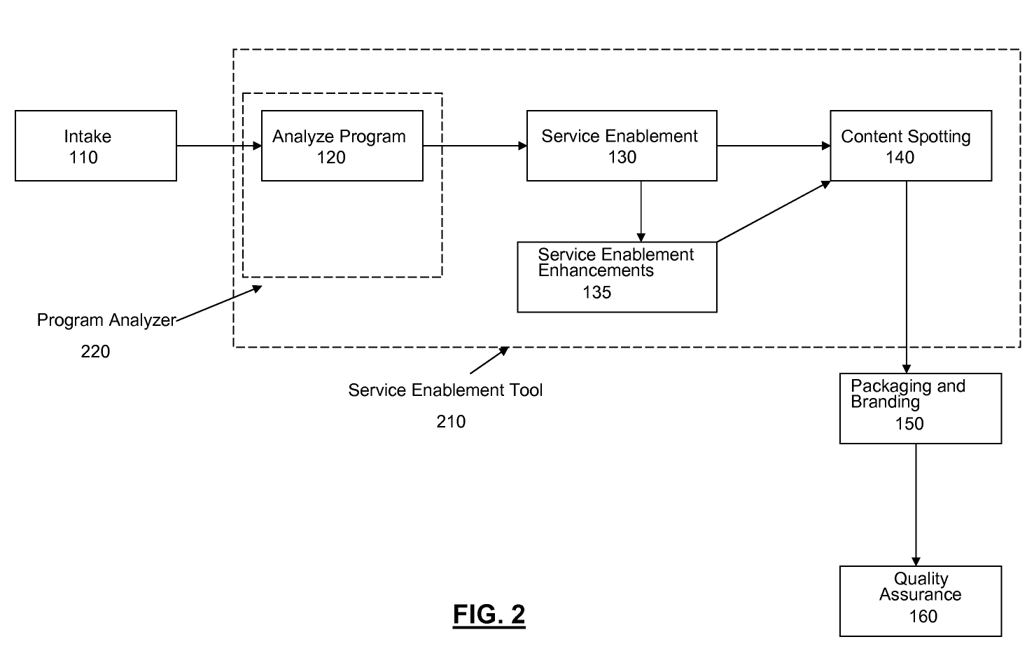

After successful completion of the service enablement, content spotting may be conducted within the game in an operation 140. A service enablement tool 210 as seen in FIG. 2 receives inputs from a service enablement technician. A service enablement technician identifies unique textures and elements of frame buffers and enters inputs signifying these textures and elements into the service enablement tool 210. The service enablement tool 210 receives the inputs from the service enablement technician and defines spots within the game where content may be displayed. An example of such a spot is a reference texture which will be further explained herein. These defined spots or reference textures are installed with the game in an encrypted configuration file. When the game is later run, proxies in an ad enablement DLL or the enablement service identify the defined reference textures and take appropriate action to present associated content or other services. Later, when the game is played by a game player content may be presented in response to the defined spots based on an established service policy. A service policy is downloaded at the start of the game from a service policy server. The service policy contains instructions as to what content will be presented, when the content will be present, and how the content will be presented.

After the game has been successfully service-enabled and the content spots have been defined within the game, the game is packaged and branded in an operation 150. The packaging process turns the output of the service enablement process into a “shelf game” that is ready for production. The packaging process produces a game Microsoft installer file (MSI) which is an installation package for the game and a game installer. The packaging process also includes digital rights management (DRM) wrapping to protect the service-enabled game. DRM-wrapping may be used to enforce a particular licensing model; e.g., a one hour “try & buy” game or a purchased game that will revert to a trial mode if it is copied to another machine. DRM-wrapping may also be used to enhance intellectual property protection; e.g., anti-debugging protection or software and media asset encryption. Furthermore, DRM-wrapping may be used to prevent tampering with the game or the enabling code for the added service. Non-limiting examples of DRM products and services that may be used include ActiveMark from Macrovision and Armadillo from Silicon Realms Toolworks. The branding process consists of creating a unique flow or display of the interfaces added to the game and its installation mechanisms at release. Different distribution portals for the games may have different branding. Distribution portals may be any entity that uses the service-enabled game, although usually a distribution portal provides a link to a game on a web site.

After the game is packaged and branded, in an operation 160, quality assurance is conducted to ensure the game functions properly when played. Quality assurance is conducted by testing the game to ensure that aspects of the game run correctly and at the correct speed and that the content successfully enables and disables at the correct times and in the correct manner. After successful completion of the quality assurance, the service-enabled game is ready for production and distribution.

FIG. 2 illustrates a service enablement tool 210 and the operations of FIG. 1 that may be performed by the service enablement tool 210. A service enablement tool 210 is a software tool that may be used to support several of the operations of the process described in FIG. 1. The service enablement tool may be stored on a memory of a computer as a computer-readable medium. The memory may be operatively connected to a CPU which may process the computer-readable medium thereby running the service enablement tool. In addition, the CPU and the memory may be connected to a display which is configured to present visual representations of the service enablement tool. The service enablement tool may be used to simply and efficiently accomplish several of the tasks involved in enabling a service within a game, thereby allowing persons less skilled in the art to service enable a game. As can be seen in FIG. 2, the service enablement tool 210 may perform the tasks of service enablement 130, service enablement enhancements 135, and content spotting 140. In addition, the service enablement tool 210 may comprise a program analyzer tool 220. The program analyzer tool 220 performs the game analysis 120 wherein the game is analyzed to determine its video and audio technologies and to determine if service-enablement is possible.

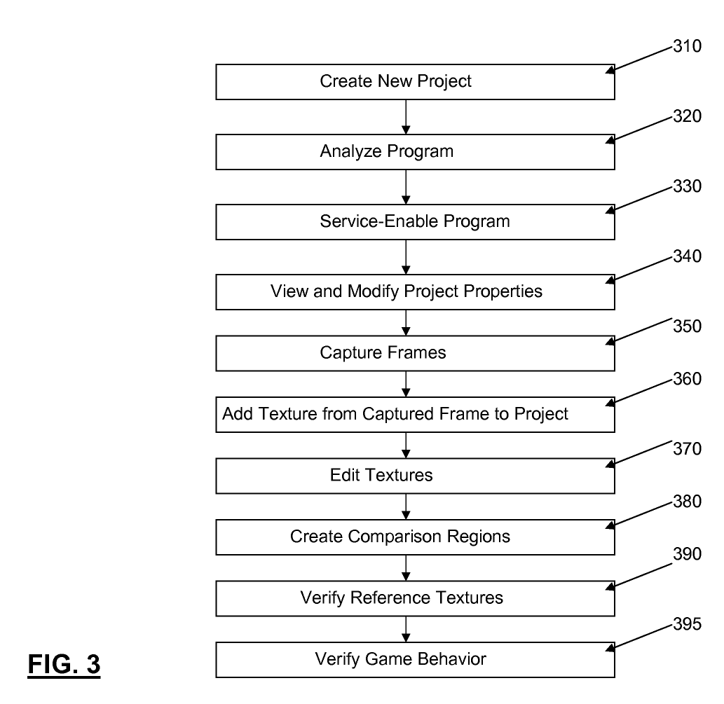

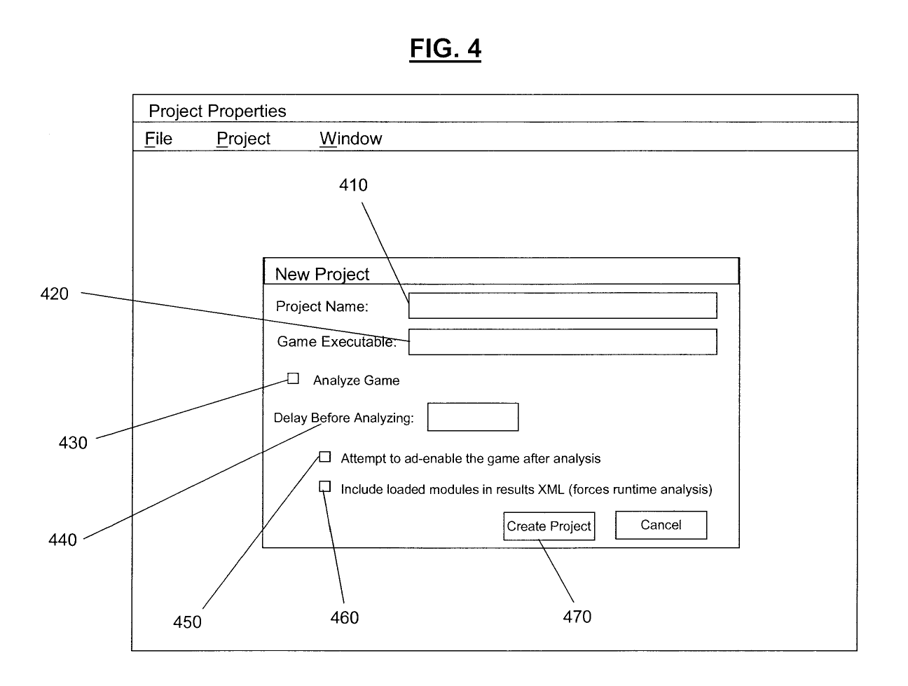

FIG. 3 is a flow diagram illustrating operations performed by an exemplary embodiment of the service enablement tool 210. This embodiment is directed toward enabling a game for insertion of advertisements, although any type of content may be inserted into the game. Upon opening the service enablement tool or a similar functioning program, a blank window appears with several menus. In an operation 310, a new project is created. A project refers to settings and data related to enabling a service within a game. In one embodiment, the new project may be created by selecting “New Project” or a similarly functioning option from a file menu. A new project window may then be presented to the user. An example new project window is described with reference to FIG. 4. The new project window may contain several options or inputs that the user may select. Example options or inputs may include one or more of the following. In a textbox 410, a project name may be inputted. A project name may be a descriptive name given to the reference texture project. The resulting output file of the service enablement tool may incorporate the project name such that the output file will be <Project Name>.rtproj. In a textbox 420, a game executable may be inputted, wherein the game executable is the executable code or path for the game that is to be service-enabled. An analyze game option 430 allows the user to determine whether the service enablement tool will attempt to determine the settings required to enable the game. A delay before analyzing option 440 allows the user to determine how long the game will be run before analyzing is conducted. This option gives the game a determined amount of time to load the libraries that may be used to provide the video and audio of the game. After this time expires, the game will be ended and analysis is performed. An attempt to ad-enable the game after analysis option 450 allows the user to determine if the service enablement tool automatically attempts to service-enable the game based on the video and audio technologies detected during the game analysis. Not selecting this option allows the service enablement technician to manually edit project settings before attempting to service-enable the game. An include load modules in the results XML option 460 allows the service enablement technician to determine if libraries that were loaded by the game executable during analysis are displayed and logged. This option may be useful for discovering what technologies are used by the game if they are not automatically detected by the service enablement tool during the game analysis. Once the appropriate inputs and options have been selected, the service enablement technician may initiate the creation of the project by selecting the create project button 470.

If the analyze game option was selected, in an operation 320 (FIG. 3), the service enablement tool triggers the program analyzer to automatically analyze the game using default project settings. During game analysis, the service enablement tool analyzes the game to determine the audio and video technologies used and to determine whether code may be injected into the game to allow enabling of services which may be used to insert content such as advertisements into a game when it is played. Games may utilize several audio and video technologies, thus the program analyzer may be capable of analyzing multiple technologies within a game. The program analyzer produces a new XML project file that contains the necessary configuration specific to the analyzed game and which will be loaded into the service enablement tool. After analysis of the game, if the attempt to ad-enable the game after analysis option is chosen, the service enablement tool automatically attempts to service-enable the game in an operation 330. In doing so, the service enablement tool attempts to hook the executable of the game. Hooking is a mechanism by which calls to audio and video application programming interfaces (APIs) are intercepted by a service that is injected into the game using a service injection tool. The service injection tool is then used to reroute game call-flow into the injected service before the audio and video APIs are called. The hooking of the executable file allows the service enablement tool to insert additional code and to ensure that the game responds to messages sent to it from the service enablement tool, the service or ad enablement DLL, the proxies, the enablement service, or a content or advertising server. Enabling the game is accomplished by modifying the game's executable to incorporate new code by using a service injection tool. Two non-limiting service injection tools used to modify the executable include EditExe and ModIAT. EditExe is based on a Microsoft technology called Detours. Detours is a library for intercepting Win32 functions. EditExe is the preferred method of enablement as it better obfuscates the function of the added code. ModIAT may be used to support games that do not react well to enabling via the EditExe method. ModIAT manually rewrites data within the game executable, thereby preserving its structure as much as possible. However, ModIAT generally makes it easier to analyze the code modifications and their functions.

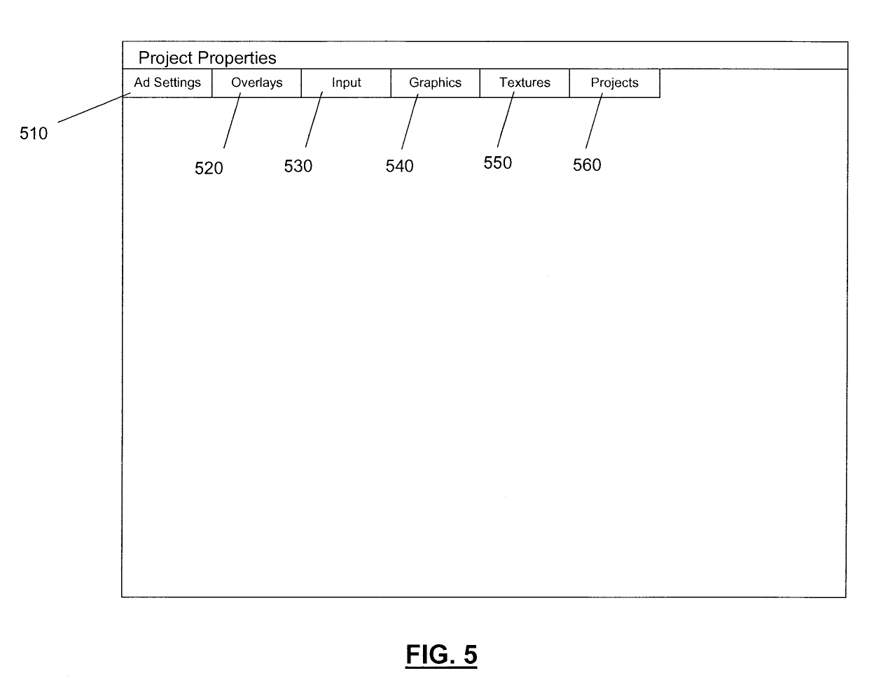

In an operation 340, the service enablement tool permits viewing and modification of project properties. In an embodiment, the service enablement technician may view and modify the project properties by selecting a project properties window from a project menu in a user interface. In an exemplary embodiment, the project properties window has six tabs although alternative embodiments may contain greater or fewer tabs as illustrated in FIG. 5. The tabs include an ad settings tab 510, an overlays tab 520, an input tab 530, a graphics tab 540, a textures tab 550, and a project tab 560. Each tab contains several changeable settings. The ad settings tab 510 contains an audio hook, music hook, custom window hook, postroll detection, and numerous flag options. The audio hook is used to specify the audio technology used in the game. The audio technology must be specified to properly suppress and restore the audio from the game when an ad plays. The music hook specifies a secondary audio technology in the event that a game uses such a technology to handle game music or other audio. The custom window hook suppresses certain messages sent to the game window. This prevents the game from stealing attention from the content window, painting over the content window, or crashing. Several non-limiting examples of options for the custom window hook including none, suppress all messages, suppress WM_ACTIVATEAPP, flash projector, and suppress deactivation. The none option does not suppress any messages to the game window. The suppress all messages option suppress all messages to the game window. The suppress WM_ACTIVATEAPP option suppresses all messages until a WM_ACTIVATEAPP message is sent, after which it stops suppressing any messages. The flash projector suppresses only WM_PAINT messages, and suppress deactivate suppresses all messages once a WM_ACTIVATEAPP message is sent indicating that the game is losing focus, e.g. minimizing. The postroll detection method specifies the method by which post-rolls are detected. Post-rolls are triggered when a game is exited and different games may have different means of requesting an application to terminate. Thus, the postroll detection method allows the service enablement technician to specify which method to use to detect different methods of requesting application termination. Several flag options may also be selected by the service enablement technician to control the content or ad settings. These flags may include requiring game player interaction to close a content window, resetting the graphics mode to the game player's settings when the content or ad plays, making in-game content windows always appear on top of the game window, sending the game window to the bottom of the window order thus allowing a click-through landing page window to pop to the front of the order, not waiting for deiconification and thereby allowing the game to resume as soon as the content goes away, and reactivating the game window the content or ad is finished playing.

The overlays tab 520 allows a service enablement technician to disable content such as ads that overlay the game window. This option may be utilized when the game becomes unstable or unusable when overlays are shown. Selecting the disable overlays option prevents overlays from being shown in the game, thereby overriding settings in the policy file which enable them. The service enablement technician also may designate a location in the game window in which the overlays are displayed. In this way, overlays do not cover up important information shown in other parts of the game window. A game supports an actionable overlays option allows the service enablement technician to designate whether a game can support the ability to remove overlay content or ads by taking selected actions. Example actions may include clicking through the content or ad using a mouse or using special key sequences.

The input tab 530 allows the service enablement technician to modify the input settings. The mouse cursor may be forced to appear when a content is played by default. The technician may deselect this default setting if the display of the mouse cursor causes problems with the game. The technician may also select an option that sends a key selection to pause the game and selects the respective key to pause the game when content such as an advertisement is to be presented. A use input focus workaround option allows the enablement service to steal focus from the game window and thereby accept a game player input when content such as an ad is played. In this way, game player inputs are allowed to function while the content is playing. This input may be selected or deselected depending on whether the game window properly regains focus when the content window disappears.

The graphics tab 540 allows the service enablement technician to control options relating to graphics of the game and content. The technician may enable or disable several options relating to DirectX 7 graphics, DirectX 8 graphics, and GDI graphics. Allowing the technician to disable several options may prevent the game from crashing due to various glitches within certain graphics technologies. Example options include options that allow the technician to disable an always trust calls to DirectDrawCreate option if interference by applications such as Flash causes an issue, instruct the service to use a different mechanism to detect when to run a preroll ad, and preserve the backbuffer when drawing overlays if overlays leave trails or otherwise do not draw correctly. Other options may allow the technician to detour and override an operating system function if the cursor disappears when moving over the content and use a dynamic method for finding the game window and to leak wrapper objects for textures thereby preventing the cleanup of the wrapper objects around the textures in order to prevent the game from crashing.

The textures tab 550 allows the service enablement technician to control settings for the textures which are defined by the game player and used to indicate when and where to present content. The technician may modify the minimum time a reference texture must appear on the screen before it is considered a match and the maximum time a reference texture must be on screen before it is no longer considered a match and content such as an advertisement is subsequently presented. In addition, the technician may specify the minimum time before a reference texture becomes valid again after it has resulted in a successful match and the content is removed. In addition, the technician can specify the upper and lower bounds of the red/green/blue components for textures with additive brightness.

In the project tab 560 the service enablement technician may enter the executable for the game that is to be service enabled. In addition, the technician may select the game class which thereby determines which hook is used to service-enable the game based on the game class's graphic technology. In addition, the technician may select the service enablement method by which the game's executable is modified; e.g., EditExe, ModIAT, etc.

If the attempt to ad-enable the game after analysis option was not chosen, the service enablement technician may select the enablement option from the project menu. Two non-limiting examples of enablement options are full service enablement and detour enablement. Full service enablement modifies the game executable and copies all relevant configuration and supporting content to run the game. This option is generally used whenever the game class is changed in the project properties because a different hook DLL must then be used. A full service enablement must be done at least once to ensure all supporting files have been copied to the game directory. The detour enablement modifies the game executable without copying the supporting files. This method should be used when the enablement method is changed in the project properties because this change does not affect the set of files required for such a change. After selecting the enablement option, the technician may service-enable the game.

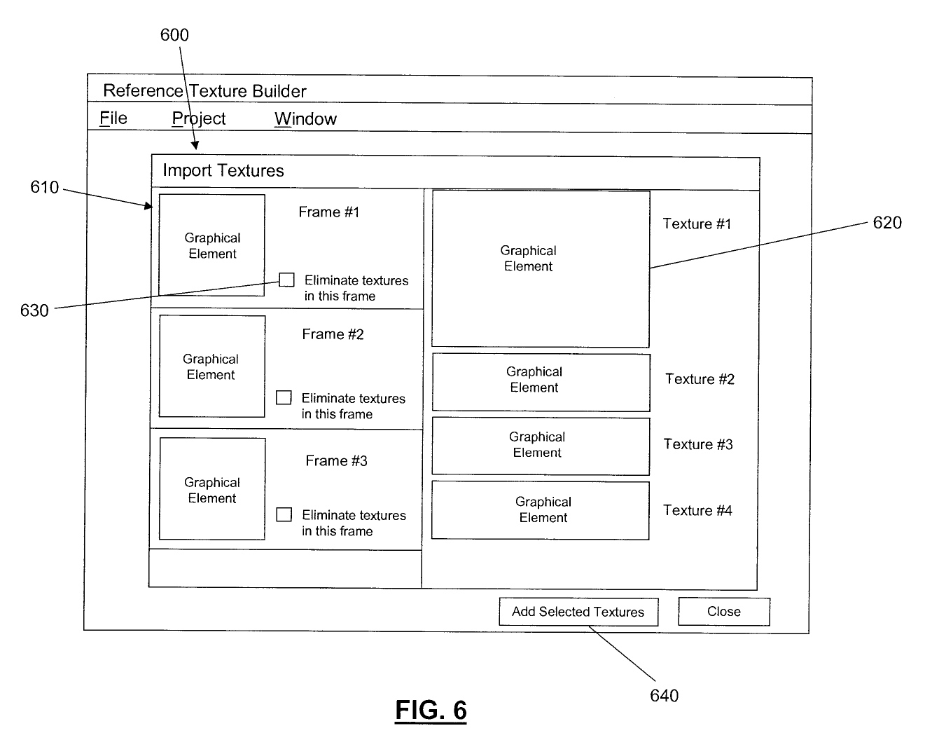

After service-enablement is completed, frames are selected and captured in an operation 350. Frames are selected and captured by running the game in the service enablement tool. In an exemplary embodiment, if the game has been successfully enabled an indicator such as a grey icon may appear in the upper-left corner of the screen to indicate the successful enablement. The service enablement technician may run the game by selecting “run game” from the project menu. While the game is running, the technician may press a selected key such as the print screen key or other key to cause the service enablement tool to capture the frame and the textures currently visible in the game. An indicator may be produced by the service enablement tool to indicate if a capture attempt was successful. For example, a “ding” sound may be produced after the captured texture has been stored by the service enablement tool. Several frames or screens produce preferred textures for content insertion. Textures from frames or screens that require user interaction to continue are preferred because, in frames or screens where the game logic or state continues as the content plays, content insertion may cause problems with the game play experience. Between-level, start-of-level, and end-of-level screens also make good candidates for reference textures. If a game is not broken into discrete levels, a texture related to a specific event such as an image shown to the user when a milestone is reached is preferred. The service enablement tool may receive inputs for a plurality of frames from the technician while running the program. The game should be run through a sufficient number of levels so that the technician grasps the game's overall behavior and a representative sample of how the state of the game changes is inputted into the service enablement tool. After closing the game, an import textures window 600 may appear, displaying all of the frames captured during the session as illustrated in FIG. 6. The import textures window 600 presents an analysis of the captured frames. The captured frames are displayed by the import textures window as seen at captured frame 610. Textures of a selected captured frame are also displayed in the import textures window of the service enablement tool as seen at texture 620. Each texture of FIG. 6 indicates the size of the texture, the number of frames in which the texture occurs, and any flags indicating special properties of the texture.

The service enablement tool includes several editing tools to aid selection of appropriate textures and frames for triggering an injected service to insert content. When the texture is selected, any corresponding frame containing the texture is highlighted in red. If the “eliminate textures that occur in this frame” box 630 is selected for an individual frame, all textures that occur in that frame are removed as potential reference texture candidates both in the individual frame and in any other frames in which the textures occur. The service enablement tool may also identify invalid textures that are captured. Invalid textures may include textures in a format not currently supported by the service enablement tool, texture files that cannot be found, or textures containing an image that is corrupt. Invalid textures are not allowed to be added as reference textures. Upon selection of a texture, the service enablement tool may present a pop-up menu with two options: add and ignore. The add option allows addition of the texture to the project as a reference texture in an operation 360. The ignore option allows the texture to be marked as ignored, wherein the texture is not added to the reference project. After one of these options is selected for the texture, the texture may be grayed-out to indicate it has been reviewed. In this way, a technician may more easily keep track of the technician's decisions. The service enablement tool may also include a button which allows the addition of single or multiple highlighted textures to the project. One or more textures may be highlighted by the service enablement tool in response to receiving an input of a specific combination of keys, for example by selection of the texture and the Ctrl key. Once one or more textures have been selected from the frames, selection of the add selected textures button 640 causes the service enablement tool to add the selected textures to the project as reference textures. This process may be repeated until all appropriate content insertion points are found and inserted. Captured textures from prior sessions may be recalled by an input to import textures from the project menu. The service enablement tool may also create reference textures from images stored on a clipboard or from images stored in a file upon receiving a selection of a clipboard or file option from the project menu.

Referring again to FIG. 3, in an operation 370, the service enablement tool provides for the editing of textures of the captured frames. An exemplary embodiment of the service enablement tool allows the service enablement technician to give descriptive names to individual textures. The names allow the texture to be easily referenced. The service enablement tool may name a texture in response to an input of a given key or by a selection of the texture, a rename texture input, and entering of a descriptive name. Textures may also be flagged to indicate special conditions about the texture. The service enablement tool may change, add, or delete the flags in response to receiving an input selecting the texture or an input selecting an edit menu and checking or unchecking values under a texture flags option. The flags may include compressed, hardware, framebuffer, additive brightness, disabled, pre-roll, overlay, and interstitial flags. Alternative embodiments may contain more or fewer flags. The compressed flag indicates that the texture is in a compressed format. The hardware flag indicates that the texture is stored on the graphics hardware. The frame buffer flag indicates that the texture is a capture of the frame buffer. The additive brightness flag indicates that variations in the texture due to brightness should be accounted for. Additive brightness flags are generally indicated in textures from games that have brightness controls. The disabled flag allows the technician to disable a texture for matching but not remove it from the project entirely. The pre-roll flag allows the pre-roll ad to be triggered within the game by the flagged referenced texture instead of before the game is started as is normally done. The overlay and interstitial flags indicate that the texture will trigger an overlay or interstitial ad, respectively.

In games that have brightness controls, tools are used to analyze the red/green/blue components in order to properly compare the textures as described below. To determine appropriate values by which to adjust the red/green/blue components, two mostly identical textures that differ mainly in brightness are captured. The first texture is captured with the game's brightness setting set to its darkest value. The second texture is captured with the game's brightness setting set to its brightest value. A comparison tool such as an auto-adjust brightness clamp is used to compare the textures and determine the adjustment values. To run the comparison tool, the auto-adjust brightness option may be selected from a pop-up menu generated by a selection of one of the textures.

Captured reference textures may also be removed from the project. The service enablement tool may delete the reference texture upon receiving a delete input from a service enablement technician when a texture is concurrently selected or highlighted.

Comparison regions are used by the injected service to compare the selected reference textures created in the service enablement tool to textures in frames of a running game or other program in order to determine when to insert content. Comparison regions reduce the number of pixels that must be compared to determine a match between a reference texture and a texture in the running game or program. Comparison regions also reduce the size of the data files distributed with the game because only the selected comparison regions are stored in the data file, whereas the project file contains the entire image and can be quite large in size. In an embodiment, the service enablement tool allows the service enablement technician to create comparison regions to allow specific portions of the textures selected by the technician to be matched to textures of the played game in an operation 380. Focusing on only a portion of the texture reduces the overhead that would be created by entire comparisons of larger textures and is particularly important when using framebuffers. When a comparison region matches a texture of a frame in a running game, the presentation of content such as an advertisement may be triggered. Multiple comparison regions can be defined per reference texture. To define a comparison region, the service enablement tool receives an input from the technician. For example, the technician may click and hold the left mouse button to drag out a rectangular region or a texture and then release the mouse button. The service enablement tool will then highlight the comparison region in the reference texture. The technician may improve the precision of the comparison region by zooming in and out of the texture prior to defining the region. The service enablement tool may allow for further adjustments to a comparison region by receiving an input from the technician in which the technician right-clicks on the region and in response the service enablement tool displays a pop-up menu. Within the pop-up menu, the technician may select from options including but not limited to make square, make power of two, and word align. The make square option adjusts the dimensions of a comparison region to make it square. The height is adjusted to match the width, and the region is anchored in the upper-right corner. The make power of two option adjusts the dimensions of the comparison region by rounding its height and width values up to the nearest power of two. For example, a height of 25 becomes 32 and a height of 87 becomes 128. The word align option adjusts the width of the comparison region by rounding down to the nearest multiple of 4. This causes the width of the resulting reference image to be equal to its stride. The service enablement tool will remove a comparison region from a reference texture when it receives a remove comparison region input from a technician. The service enablement tool also may present a remove all option which allows the technician to give the service enablement tool an input to remove every comparison region from a reference texture.

A current project may be saved and closed in the service enablement tool prior to finishing the reference texture selection. The service enablement tool will save an existing project upon a selection of a save project or save project as option from the file menu. Saving the project saves the current settings and textures to a project file. The saved project file may then be opened at a later time by selecting an open project option from the file menu. The technician may then begin work on the project within the service enablement tool from the point where the technician previously left off prior to saving the project.

After the reference textures have been selected and successfully loaded, the reference textures are verified in an operation 390. An indicator such as a green icon may be used to indicate that the reference textures have been successfully loaded. In verifying the reference textures, each reference texture is tested to confirm that the reference texture triggers the injected service such that the injected service may insert content such as an ad into the game as prescribed by the service policy. If content does not appear for a reference texture or the game runs noticeably slower, the technician should investigate the reason for the problem. The problem may be a result of the particular reference texture or the settings of the service enablement tool.

After the reference textures have been verified, the game behavior is verified in an operation 395. The game behavior may be verified by running the game and testing the overall game behavior to verify that the correct options have been chosen for enabling the game. The pre-roll and post-roll ads may be observed to make sure they are properly displayed, that they run and close correctly, and that they do not cause problems when starting or ending the game. The game sound should properly pause when content is displayed and restore once the content window closes. The game sound can be checked by using interstitial content or ads which may be forced to play without the presence of a reference texture by entering a special key sequence. Clicking on content should bring up the corresponding web page in a browser if the game is so enabled, the game window should stay minimized or visible as expected, and the focus should be successfully returned to the game window after clicking on the content. The game may also be tested in full screen and windowed mode and at each supported resolution. The cursor should also be visible outside the content window. If no issues are encountered, the game has been successfully service-enabled. The end product produced by the service enablement tool is a .rtproj file which is an XML project file. In a publish operation, the .rtproj file is copied to a shared folder and an email is composed containing the details of the service-enablement. These details may include the audio hook, the DLL used, the texture names needed to indicate the trigger points for the injected service, and the technician-entered information such as the publisher and portal, the bug number, and the time required. The .rtproj file is later inputted into a packaging and branding system that creates a production ready version of the game that contains a compact binary data file with the necessary information to insert content at the desired points within the game. In an alternative embodiment, the .rtproj file may be posted to a web service which is connected to a database.

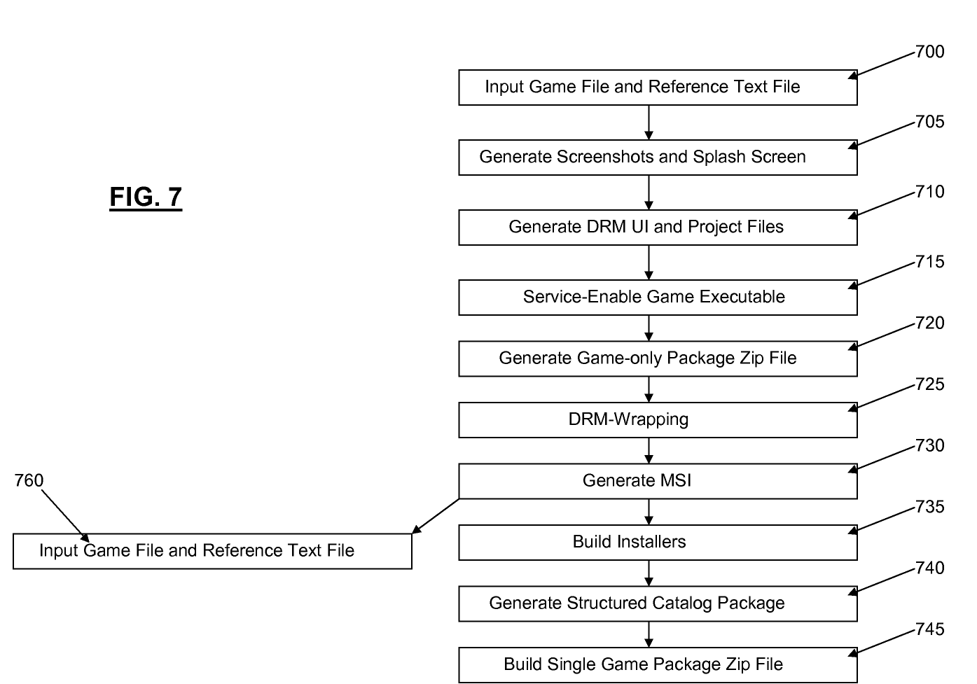

Representative operations of the packaging and branding process conducted by a packaging tool are shown in FIG. 7. In an operation 700, the packaging tool receives an unmodified, compiled game from a game publisher and a reference text project file from the service enablement tool as inputs. In an operation 705, the packaging tool generates the game's screenshots and splash screen from screen selections inputted by a technician. The screenshots and splash screens are images captured from the running game which are used later for branding of various screens such as an installer screen, a nag screen, or a content window. The splash screen is generated by utilizing a resized screenshot, game title, or other appropriate image. In an operation 710, the packaging tool generates digital rights management (DRM) user interfaces, e.g., nag screens, and various project files by utilizing a set of template files with configurable values. The configurable values may represent a game title, price, key features, or settings for DRM-wrapping and are mapped to specific portals or groups of portals from where a completed game may later be accessed by a game player. DRM products used later to DRM-wrap the game provide nag screens before and after the game play. These nag screens are customizable. The packaging tool may utilize a customized nag screen in order to implement a unique, customized branding for the particular game. These customized nag screens are generally used for branding games for larger clients. Branding consists of creating a unique flow or display of the interfaces added to the game and its installation mechanisms. Alternatively, the packaging tool may utilize a generic nag screen in order to allow later branding after the packaging and testing of the game. Different clients and distribution portals for the games may have different branding. A distribution portal is any entity that uses the service-enabled game, although usually a distribution portal provides a link to a game on a web site. This technique of branding after the packaging and testing increases the efficiency and cost savings of packaging, testing, and branding games for multiple clients or portals because a game may be re-branded multiple times without having to be repackaged or retested. In addition, DRM branding elements such as the user interface flow, the layout, and the graphics may also be customized at the client or portal level.

In an operation 715, the game executable is service-enabled using the output file from the service enablement tool as an input. To service-enable the executable, a service injection tool is run against the game executable to preserve the executable's structure. In a preferred embodiment, this service injection tool is ModIAT.exe. A compiling tool is then run to compile the service enablement tool project file. The compiling tool generates an RT.DAT file. The compiling tool is then run again to service-enable the game executable. The compiling tool service-enables the game by modifying the game executable using another service injection tool, preferably EditExe.exe. In addition, the packaging tool may generate a debug file from the service enablement for troubleshooting purposes.

In an operation 720, the packaging tool generates a game-only package zip file. This package contains the service-enabled game along with all of the game files and service-enablement components. This game package is useful for debugging and can be delivered to a client who wishes to perform its own DRM-wrapping. In an operation 725, the game may optionally be DRM-wrapped. DRM-wrapping may be used to enforce a particular licensing model; e.g., a one hour “try and buy” game or a purchased game that will revert to a trial mode if it is copied to another machine. DRM-wrapping may also be used to enhance intellectual property protection; e.g., anti-debugging protection or software and media asset encryption. Furthermore, DRM-wrapping may be used to prevent tampering with the game or the enabling code for the service. DRM-wrapping may be performed using DRM services such as ActiveMark from Macrovision or Armadillo from Silicon Realms Toolworks. The DRM service incorporates the project files and values from operation 710 in the DRM-wrapping. DRM-wrapping may be disabled in the packaging tool in order to perform debugging or to enable a client to DRM-wrap the game.

In an operation 730, the packaging tool runs a Microsoft Installer (MSI) generation tool which generates a game MSI. The MSI is an installation package for the game. The MSI generation tool uses a Windows Installer XML toolset to create the MSI. The generated MSI may optionally not contain a resources DLL for the installer and content screens. This enables the resources DLL to be attached later when the installer is built so that branding of the installer and content screens can be then be applied.

In an operation 735, bundled and non-bundled installers are built. The bundled installers are packaged with all the files created by the packaging tool so that the game can be installed from it without further downloads from a server. As such, the bundled installers may be used for testing, to upload to a server so that a game player can recover a purchased game, and for delivery to a client or portal that would like to host the game installer. The non-bundled installers do not contain all of the files created by the packaging tool and are built primarily for testing purposes. To build the installers, the packaging tool extracts a game icon and replaces an icon in a game installer with the extracted icon. The game installer is responsible for displaying the game splash screen, the installation screen flow, launching the game's MSI, and installing the portal branding components. The packaging tool then generates configuration files for the bundled and non-bundled installers from the template files and configurable values of operation 710. An installer manifest file for the bundled installer is generated and signed.

The packaging tool then attaches files to the game installer using an attacher tool. The attached files may include the installer manifest, the configuration, the splash screens, the screenshots, and the brander resource DLL. For the bundled installer, the game MSI is also attached. The attacher tool thereby generates a game installer. The game installer is an executable that provides a user interface that collects user inputs and then applies that input to the execution of a game MSI. The game installer allows the modified game to be downloaded by a game player. The game installer may be a bundled game installer or a dynamic game installer. In a bundled game installer, the MSI is bundled into the game installer file. A dynamic game installer is created dynamically and can embed information about the installer request. The dynamic game installer does not include the game MSI. When using a dynamic game installer, the game MSI is instead downloaded when the installer is executed. The packaging tool then runs the resource builder tool to change the version number in the bundled and non-bundled installers to match the game's build version number and to rename the installers based on the game name.

As seen above, the packaging tool can be configured to generate files for different packaging scenarios. For example, the packaging tool may be configured to generate service-enabled games with DRM-wrapping and a bundled installer that includes all the files created by the packaging tool. On the other hand, a client or portal may prefer a service-enabled game with no DRM-wrapping and no installer. This may be common with generic portals that do not require installers with the games. These generic portals may only require a game MSI, a game screenshot, and installer configuration files. In this case, these files are placed on an installer packager tool. The installer packager tool builds the installers when the game is downloaded from the portal. This allows portal or client specific branding without the need for repackaging or retesting the game. Branding of the installer/uninstaller and service-enablement screens may be applied by the installer packager tool. These screens are built as resources within a resource DLL and are not written into the source code of the game. Thus, alternatively to operation 735, in an operation 760, the installer packager tool may build the installer when the game is downloaded. The installer packager tool is stored on a server and monitors game download requests. The installer packager tool allows the installer and the service-enablement screens to be included at game download time. The branding resource DLLs that relate to these screens are packaged into the installer by the installer packager tool when a game download is requested. As such, the game is built once with generic DRM nag screens and then packaged into a single MSI by the packaging tool in an operation 630 but without the installer and service-enablement screens. These screens are then later bundled into the installer by the installer packager tool based on the game and portal of the download request in an operation 760. In this way, service-enabled games may be delivered to additional portals with a unique branding without repackaging or retesting the service-enabled games.

In an operation 740, a structured catalog package is generated that can be used to import the game into a catalog database. The structured catalog package is generated by creating a packaging file that allows the game to be accurately and efficiently added to a catalog. In an operation 745, the packaging tool builds a single game package zip file. The single game package zip file includes all of the files generated by the packaging tool. These files may include the game-only package, the MSI, the bundled and non-bundled installers, the catalog package, the service-enablement debug components, the DRM user interface and project files, the packaging log file, and a build summary. In an operation 750, the packaging tool deposits the game package zip file, the MSI, and the version file into a content repository.

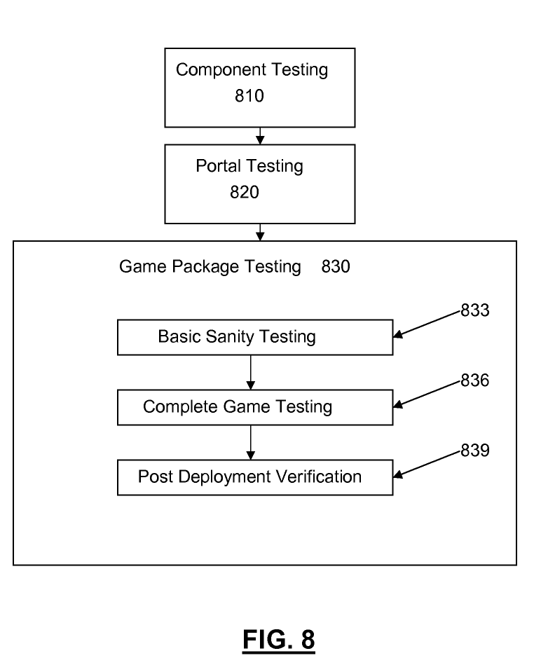

FIG. 8 is a flow diagram illustrating the testing and quality assurance performed to ensure the packaged games function properly. In an embodiment, quality assurance is performed after the service-enabled game has been successfully packaged. In an operation 810, components involved in the service-enabling and packaging processes are tested separately. These components may include but are not limited to an installer, the service enablement tool, DRM-wrapping, the packaging tool, the content or ad network, and a reporting interface. In an operation 820, new portal configurations are tested one time with a sample set of games. Portal configurations that successfully complete testing may then be applied to other games at runtime without need for additional testing. Portal testing consists of verification of portal parameters. Example portal parameters may include a portal name, a portal game default price, a site ID, a set of offline content or ads for the portal, a default game install location, a flash prerequisite, a cancel survey URL, a privacy policy, a post roll promotional URL, a portal start menu display name, a portal add/remove program display name, and a portal desktop shortcut display name.

In an operation 830, the game package is tested. Game package testing includes basic sanity testing, complete game system testing, and post deployment verification. A packaged game first undergoes basic sanity testing in an operation 833. Basic sanity testing confirms that the packaged game can be installed, played, and uninstalled as expected. Basic sanity testing is designed to determine if more extensive testing, such as complete game testing, should be performed on the game package.

After completion of the basic sanity testing, complete game testing is performed on the game package in an operation 836. Complete game testing is a semi-automated testing process that ensures the game data, licensing models, game flows, service policies, and reporting interfaces function according to established requirements and ensures that the packaged game is compatible with all intended platforms. An automated game testing tool looks up the game requirements from a requirements database, executes test cases according to the game requirements, and generates a test execution log. The testing tool runs a traffic capture utility that captures http traffic at the time of game play and parses the captured http traffic to ensure that all excepted reporting events have correctly occurred. In addition, manual testing is conducted on test cases that are not automated and to ensure that the game performance and content insertions meet an acceptable quality standard. The manual and automated test cases are executed on different machines with a variety of environment variables to ensure that the game is stable and functions as expected for selected environment variables. These environment variables may include operating systems, browser versions, antivirus programs and firewalls, graphic cards, various hardware configurations, user access control levels, and various display resolutions and settings. As a part of the test case execution, the testing tool ensures that the game is packaged according to the game requirements. Example game requirements which the game may be tested against may include the game name, trial duration, purchase price, and default service policy. The test cases may include game flow test cases, service enablement test cases, game play test cases, and purchase test cases among others. The game flow test case may be used to verify user interface screens, third party links, game customizations, offline content behavior, and uninstall functions. The service enablement test cases may be used to verify the game's stability after service insertion, the functionality of the actionable content such as ads, the game play settings, the default service policy and the optimum content positions. The game play test cases may be used to verify the game play and the game state retention. The purchase test cases may be used to verify that the game can be purchased, that inserted services does not appear in a purchased game, and that purchase and uninstall of old versions of a game on a machine does not affect install and game play of a new version of the game on the same machine. After completion of complete game testing the game is ready for production and distribution.

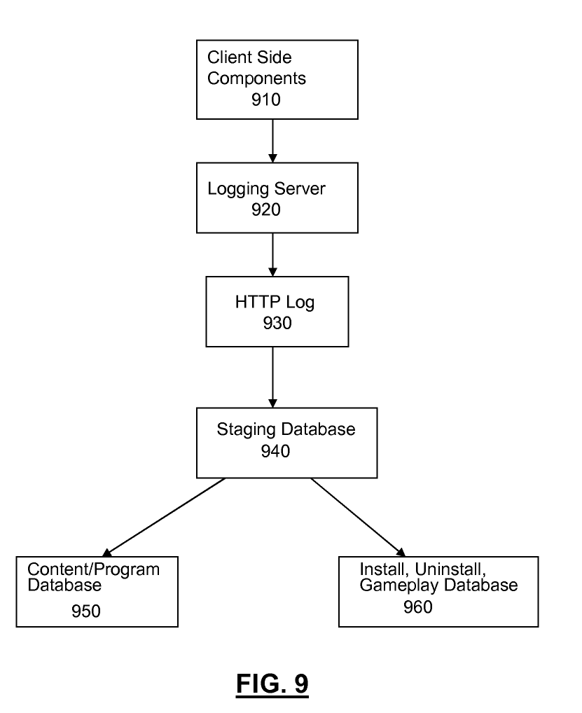

After the game is produced and distributed, in an operation 839 of FIG. 8, post deployment verification may be performed to ensure the game works properly. An exemplary embodiment of post deployment verification is now described. Alternative embodiments may contain additional or fewer elements or steps. Repeated reference is made to analysis of a “game.” Please note that other types of service-enabled computer programs may be analyzed and verified in the same manner. FIG. 9 illustrates infrastructure associated with post deployment verification. During packaging, many client side components 910 such as service-enablement DLLs, installers, uninstallers, DRM nag screens, and content frames are configured so that these components cause various data to be reported back to logging servers. The data is received at a logging server 920 as a result of HTTP requests. After receiving the data, the logging server 920 records the data in standard HTTP logs 930. The recorded data may include a unique integer identifier, a globally unique identifier, and/or further descriptive information so that the data may be easily referenced within a database. Exact, transform, and load (ETL) scripts may then be used to extract the data from the HTTP logs 930 and upload them to a staging database 940. Additional ETL scripts are used to extract the data from the staging database 940 and populate two additional reporting databases 950, 960. A first reporting database 950 is directed mainly toward content and program purchase data. A second reporting database 960 is directed mainly toward install, uninstall, and program or game play data. In an alternative embodiment, a single database may store all the data. The data is then organized within the reporting databases based on the data identifiers and descriptive information so that reports and metrics based on the data can be easily formulated.

This data can be evaluated to analyze various metrics such as the following performance indicators. This evaluation may include testing of the overall portal status, the install success rate, the conversion rate, the uninstall rate, the service enablement success rate, the game play duration, and the click through rate. Additional or fewer metrics may be analyzed. The install success rate is the percentage of the installations completed successfully. A poor install success rate may indicate problems with the installer of the game or in other areas related to installation. The conversion rate is the ratio of the users who purchased a game to those who download the game in a given time period. A poor conversion rate may indicate problems in game purchase flow. The uninstall rate is the percentage of people who uninstalled the game to those who installed it in that time period. The game play duration is an average of the play duration of all game plays for a particular game in a given time period. A high uninstall rate or low game play duration may indicate bad user experiences with the game which could be related to packaging or service enablement problems. The service enablement success rate is the ratio of content actually shown in the game to the maximum content that could have been shown in the game. A low service enablement success rate may indicate sub-optimal texture selection or problems in service enablement. The click through rate is the ratio of content that is selected to the total content for a game in a given time period. The click through rate may be used by an advertiser to indicate that a consumer showed interest in an advertised product. In addition, an abnormal click through rate may indicate problems in service enablement. Metrics such as those described above may be used to determine if the service enabled program or game falls within an acceptable threshold. If a program or game is not within an acceptable threshold, further analysis may be conducted to repair the program or game to place it within an acceptable threshold.

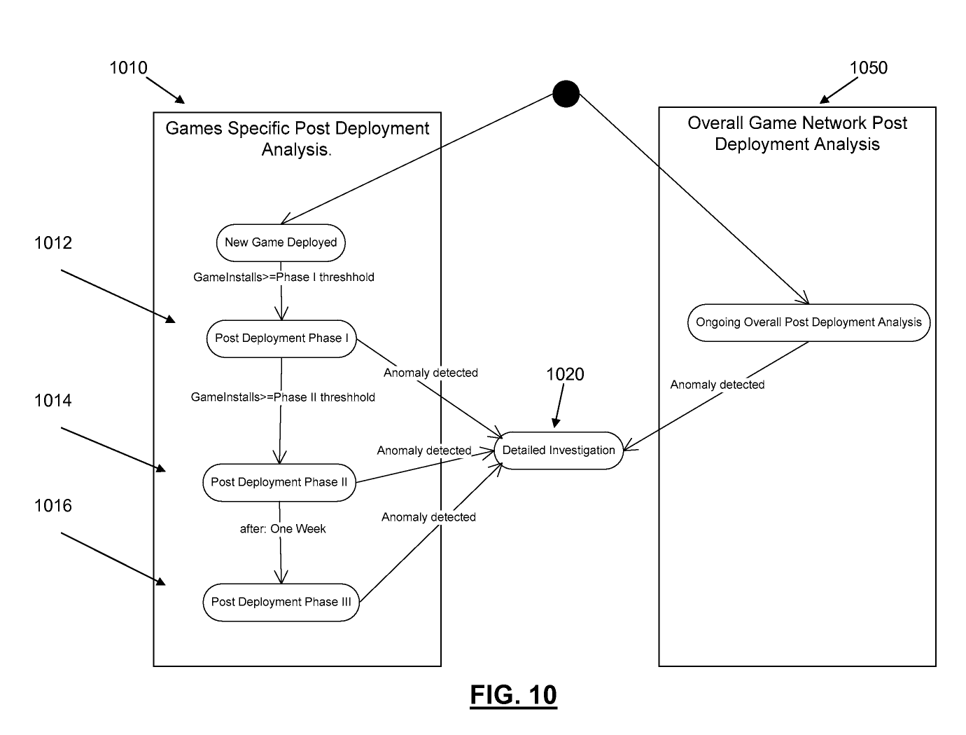

FIG. 10 illustrates an exemplary post deployment verification process. The post deployment verification process may include network analysis 1050 and game or program specific analysis 1010. In the network analysis 1050, analysis is performed based on the data that various games send back during install, game play, and uninstall. Metrics such as those described in the preceding paragraph may be used to find problems caused due to web services that the program or game depends on such as a content network, DRM web services, or service policy services. In addition, problems caused by updates in environment variables such as an operating system service pack, a browser, a flash antivirus program, or a content block product may also be discovered.

Game specific analysis 1010 may also be performed after an individual game has been deployed to ensure that the game is functioning properly. In an embodiment, game specific analysis 1010 includes three analysis phases. Phase I is conducted in block 1012 after a sufficient amount of installs of the game have been obtained. Phase I may include analysis of install success rates, uninstall rates, and game play duration as described above. Once the number of installs of the game has reached a second threshold, Phase II analysis in block 1014 is conducted. Phase II includes analysis of the interstitial ads displayed per gameplay, the game play duration distributions for the game, and the service enablement success rate. Trends of these metrics are analyzed to ensure game play and service enablement is functioning properly. After Phase II analysis, Phase III 1016 may be conducted in block 1016. Phase III is directed towards business metrics that may indicate profitability. Such metrics may include the average content displayed per download. If the game has metrics or performance indicators outside of an acceptable threshold after any of the phases, further investigation may be conducted in an operation 1020. In this way, post deployment verification is used to analyze the success and performance of specific service enabled computer programs and games as well as the network associated with the programs and games so that any uncovered problems may be repaired.

The foregoing description has been presented for purposes of illustration and of description. It is not intended to be exhaustive or limiting with respect to the precise form disclosed, and modifications and variations are possible in light of the above teachings or may be acquired from practice of the disclosed embodiments.

What is claimed is:

1. A method for injecting a service into a computer program, the method comprising:
analyzing a computer program via a program analyzer, wherein the program analyzer is configured to determine if the computer program may be service-enabled;
receiving a first input via a user interface, wherein the first input is configured to define an object within the computer program; and
modifying the computer program via a service enablement tool, wherein the service enablement tool is configured to insert an injected service into the computer program, and wherein the injected service is configured to respond to an occurrence of the object.

2. The method of claim 1, wherein the service enablement tool is configured to insert the injected service into an executable file of the computer program by modifying the executable file.

3. The method of claim 1, wherein the service is configured to cause content to be presented in response to the occurrence of the object.

4. The method of claim 3, wherein the computer program comprises a software game and wherein the content comprises an advertisement.

5. The method of claim 3, wherein the content is to be presented according to a service policy.

6. The method of claim 1, further comprising running the computer program.

7. The method of claim 6, wherein the defined object is selected from a plurality of objects captured while running the computer program.

8. The method of claim 7, further comprising receiving a second input, wherein the second input is configured to edit the captured objects.

9. The method of claim 8, further comprising receiving a third input, wherein the third input is configured to define a comparison region, wherein the comparison region is a smaller portion of the object within the computer program, and wherein the injected service is configured to respond to an occurrence of the comparison region.

10. The method of claim 1, further comprising packaging the modified computer program, wherein packaging the modified computer program comprises generating a game installer configured to install the modified computer program.

11. The method of claim 10, further comprising branding the modified computer program, wherein the branding the modified computer program comprises creating a unique display of an interface of the modified computer program.

12. The method of claim 11, further comprising testing the modified computer program to ensure the modified computer program functions properly.

13. The method of claim 12, wherein at least a portion of the testing the modified computer program is automated.

14. The method of claim 12, wherein the testing the modified computer program comprises preliminary game testing, complete game testing, and post deployment testing.

15. The method of claim 9, further comprising rebranding the modified computer program without repackaging or retesting the modified computer program.

16. The method of claim 9, further comprising branding the modified computer program when the modified computer program is downloaded from a portal.

17. The method of claim 1, further comprising applying digital rights management to the modified computer program.

18. The method of claim 1, further comprising performing post deployment testing, wherein the post deployment testing comprises:
receiving data from a component of the modified computer program at a database after deployment of the modified computer program; and
creating performance indicators from the stored data at the database.

19. A device for injecting a service into a computer program, the device comprising:
an application, the application comprising computer code configured to
run a computer program,
define at least one object from the computer program in response to a first user input, and
insert a service into the computer program, wherein the service is configured to respond to an occurrence of the at least one object;
a memory, wherein the memory is configured to store the application; and
a processor, wherein the processor is coupled to the memory and configured to execute the application.

20. The device of claim 19, wherein the computer program is a software game and wherein the content is an advertisement.

21. The device of claim 19, wherein the insert a service into the computer program includes modifying an executable file of the computer program.

22. The device of claim 19, wherein the computer code is further configured to cause a display of the at least one defined object and a selected portion of at least one captured frame.

23. The device of claim 19, wherein the inserted service is configured to cause content to be presented in response to the occurrence of the at least one object.

24. The device of claim 23, wherein the computer code is further configured to define a smaller portion of the at least one defined object in response to a second user input, and wherein the service is further configured to cause the content to be presented in response to an occurrence of the defined smaller portion.

25. The device of claim 19, wherein the computer code is further configured to package the enabled computer program, wherein packaging the enabled computer program comprises generating an installer configured to install the enabled computer program.

26. The device of claim 25, wherein the packaged computer program comprises the modified executable file, and wherein the packaged computer program includes the inserted service.

27. The device of claim 25, wherein the computer code is further configured to brand the enabled computer program, wherein the branding the enabled computer program comprises creating a unique display of an interface of the enabled computer program.

28. The device of claim 27, wherein the computer code is further configured to test the enabled computer program to ensure the enabled computer program functions properly.

29. The device of claim 28, wherein at least a portion of the testing the enabled computer program is automated.

30. The device of claim 28, wherein the computer code is further configured to rebrand the enabled computer program without repackaging or retesting the enabled computer program.

31. A tool for injecting a service into a software game, the tool comprising:
a program analyzer configured to analyze a video technology and an audio technology of a game;
a service enablement tool configured to
receive a selected spot within the game where content may be presented, and
modify a game by inserting a service into the game, wherein the service is configured to respond to an occurrence of the selected spot.

32. The tool of claim 31, wherein the service is configured to cause the content to be presented at the selected spot.

33. The tool of claim 32, wherein the service is configured to cause an advertisement to be presented before or after play of the game.

34. The tool of claim 31 wherein the modify a game comprises modifying the executable file of the game.

35. The tool of claim 31, wherein the service enablement tool comprises the program analyzer.

36. The tool of claim 31, further comprising a packaging tool configured to generate a game installer configured to install the modified game.

37. The tool of claim 36, wherein the packaging tool is further configured to create a unique display of an interface of the modified game.

38. The tool of claim 36, further comprising a testing tool configured to check if the modified game functions properly.

39. A computer-readable medium having computer-readable instructions stored thereon, which when executed by a processor, cause a computing device to:
analyze a computer program to determine if the computer program may be service-enabled;
receive a first input, wherein the first input is configured to define an object within the computer program; and
modify the computer program by inserting an injected service into the computer program, wherein the injected service is configured to respond to an occurrence of the object.

40. The computer-readable medium of claim 39, wherein the injected service is configured to cause content to be presented in response to the occurrence of the object.

41. The computer-readable medium of claim 40, wherein the computer program comprises a software game and wherein the content comprises an advertisement.

42. The computer-readable medium of claim 39, wherein the computer-readable instructions further cause a computing device to run the computer program.

43. The computer-readable medium of claim 39, wherein the defined object is selected from a plurality of objects captured while running the computer program.

44. The computer-readable medium of claim 43, wherein the computer-readable instructions further cause a computing device to receive a second input, wherein the second input is configured to edit the captured objects.

45. The computer-readable medium of claim 44, wherein the computer-readable instructions further cause a computing device to receive a third input, wherein the third input is configured to define a comparison region, and wherein the comparison region is a smaller portion of the defined object.

46. The computer-readable medium of claim 39, wherein modifying the computer program comprises modifying an executable file of the game.

47. The computer-readable medium of claim 46, wherein the computer-readable instructions further cause a computing device to package the modified computer program, wherein packaging the modified computer program comprises generating an installer configured to install the modified computer program.

48. The computer-readable medium of claim 47, wherein the computer-readable instructions further cause a computing device to brand the modified computer program, wherein the branding the modified computer program comprises creating a unique display of an interface of the modified computer program.

49. The computer-readable medium of claim 48, wherein the computer-readable instructions further cause a computing device to test the modified computer program to ensure the modified computer program functions properly.

50. The computer-readable medium of claim 49, wherein the computer-readable instructions further cause a computing device to rebrand the modified computer program without repackaging or retesting the modified computer program.
